(19) United States
(12) Patent Application Publication
(10) Pub. No.: US 2018/0251391 A1
(43) Pub. Date: Sep. 6, 2018

(54) ROD BUNDLE AND METHOD OF MANUFACTURING OPTICAL FIBER

(71) Applicant: FUJIKURA LTD., Tokyo (JP)

(72) Inventor: Ryohei Fukumoto, Sakura-shi (JP)

(73) Assignee: FUJIKURA LTD., Tokyo (JP)

(21) Appl. No.: 15/891,130

(22) Filed: Feb. 7, 2018

(30) Foreign Application Priority Data
Mar. 6, 2017 (JP) 2017-042175

(51) Int. Cl. C03B 37/012; C03B 37/014; C03B 37/028

(52) U.S. Cl. CPC C03B 37/01205; C03B 2203/40; C03B 37/028; C03B 37/01446

(57) ABSTRACT

A rod bundle includes a core-clad rod that includes a core rod and a cladding layer that covers the core rod, a plurality of first filling rods disposed around the core-clad rod to be in contact with the core-clad rod, and two second filling rods that are disposed opposite to each other and interposing the core-clad rod therebetween to be distant from the core-clad rod and form first spaces with the core-clad rod. The rod bundle also includes a pair of second spaces that are next to the core-clad rod are formed to interpose the core-clad rod therebetween in a direction perpendicular to a direction in which the two second filling rods are opposite to each other and, in a transverse plane, an area of each of the first spaces is more than an area of each of second spaces.

### BACKGROUND

### Field of the Invention

The present invention relates to a rod bundle and a method of manufacturing an optical fiber.

Priority is claimed on Japanese Patent Application No. 2017-042175, filed on Mar. 6, 2017, the content of which is incorporated herein by reference.

### Description of Related Art

Recently, network traffic has increased. In order to extend transmission capacity, a few-mode fiber (FMF) that propagates not only a single mode but also multiple modes such as two or three modes using one core has attracted attention. As disclosed in Japanese Unexamined Patent Application, First Publication No. 2015-178444, an FMF can be manufactured using a rod bundle into which a core-clad rod and a filling rod are bundled.

An FMF propagates multiple modes using one core. Therefore, in order to extract signals, a signal which is multiplexed through a multiple-input and multiple-output (MIMO) process may be demultiplexed.

On the other hand, it is desired to omit the MIMO process from the viewpoints of reducing the costs and simplifying the device. Regarding this point, Giovanni Milione et al., “1.2-Tb/s MIMO-less Transmission Over 1 km of Four-Core Elliptical-Core Few-Mode Fiber with 125-μ Diameter Cladding”, OECC/PS2016 discloses that the MIMO process can be omitted by making the shape of a core to be elliptical.

However, Japanese Unexamined Patent Application, First Publication No. 2015-178444 does not disclose a method of intentionally forming a core having an elliptical shape in a transverse plane.

On the other hand, Japanese Patent (Granted) Publication No. 4652613 discloses that an optical fiber that includes a core having an elliptical shape in a transverse plane can be manufactured by cutting a part of a clad portion of an optical fiber preform in a longitudinal direction of the optical fiber preform. However, it is difficult to cut the optical fiber preform in the longitudinal direction, and the quality stability, manufacturing efficiency, manufacturing costs, and the like of an optical fiber may be insufficient.

### SUMMARY

One or more embodiments of the present invention provide a rod bundle and a method of manufacturing an optical fiber, in which an optical fiber including an elliptical core can be easily manufactured.

According to one or more embodiments of the present invention, there is provided a rod bundle including: a core-clad rod that includes a core rod and a cladding layer covering the core rod; a plurality of first filling rods that are disposed around the core-clad rod so as to be in contact with the core-clad rod; and two second filling rods that are disposed opposite to each other interposing the core-clad rod therebetween to be distant from the core-clad rod and form first spaces with the core-clad rod, in which a pair of second spaces that are adjacent to the core-clad rod are formed so as to interpose the core-clad rod therebetween in a direction perpendicular to a direction in which the two second filling rods are opposite to each other, and in a transverse plane, an area of each of the first spaces is more than an area of each of the second spaces.

In the rod bundle according to one or more embodiments in the transverse plane, a pair of first spaces and a pair of second spaces between which the core-clad rod is interposed in a radial direction are formed, and the area of each of the first spaces is larger than the area of each of the second spaces. Therefore, in a case where the rod bundle is sintered or drawn in steps of manufacturing an optical fiber, in the core rod, a compressive force applied in a direction in which the pair of second spaces are opposite to each other, which is perpendicular to the direction in which the pair of first spaces are opposite to each other, is higher than that applied in the direction in which the pair of first spaces are opposite to each other. Due to a difference in compressive force, the core rod is deformed to escape toward the first spaces.

As a result, in the transverse plane, the core of the optical fiber can be easily formed in an elliptical shape which has a major axis extending in the direction in which the pair of first spaces are opposite to each other and a minor axis extending in the direction in which the pair of second spaces are opposite to each other.

In the rod bundle according to one or more embodiments, the number of the first filling rods is four, the first filling rods may have a larger diameter than the core-clad rod, the second filling rods may have a smaller diameter than the first filling rods, and each of the first spaces may be formed by respective outer circumferential surfaces of the core-clad rod, two of the first filling rods, and each of the second filling rods.

In this case, the shape of the rod bundle in the transverse plane is substantially circular as a whole. Therefore, in a case where an optical fiber preform is prepared using the rod bundle, the optical fiber preform can be easily manufactured in a substantially cylindrical shape. Further, the first space is formed by the outer circumferential surfaces of the four rods. Therefore, the area of the first space is stabilized, and the core can be formed in a desired elliptical shape.

In addition, the rod bundle according to one or more embodiments may further include two third filling rods having a smaller diameter than the first filling rods and the second filling rods, in which each of the third filling rods may be in contact with two of the first filling rods from a radially outside.

In this case, due to the two third filling rods, the shape of the rod bundle in the transverse plane can be made to be more similar to a circular shape.

According to one or more embodiments of the present invention, there is provided a rod bundle including: a fourth filling rod; and a plurality of core-clad rods that are disposed around the fourth filling rod so as to be in contact with the fourth filling rod, each of the core-clad rods including a core rod and a cladding layer covering the core rod, in which third spaces are formed between the core-clad rods in a circumferential direction.

In the rod bundle according to one or more embodiments, a plurality of core-clad rods are disposed around the fourth filling rod, and the third spaces are formed between the core-clad rods. Therefore, in a case where the rod bundle is sintered or drawn in steps of manufacturing an optical fiber, the core rods receive a compressive force from the fourth filling rod and are deformed to escape toward the third spaces in the circumferential direction. Accordingly, in a transverse plane, the optical fiber including a plurality of elliptical cores which have major axes extending in the circumferential direction and minor axes extending in the radial direction can be easily formed.

Here, the rod bundle according to one or more embodiments may further include a fifth filling rod having a smaller diameter than the core-clad rods and the fourth filling rod, wherein the fifth filling rod is disposed between a pair of the core-clad rods adjacent to each other in the circumferential direction.

In this case, due to the fifth filling rod, the distance between a pair of the core-clad rods adjacent to each other in the circumferential direction is stabilized. As a result, the size of the third space can be stabilized, and the cores of the optical fiber can be easily formed in a desired elliptical shape.

According to one or more embodiments of the present invention, there is provided a method of manufacturing an optical fiber including: a step of depositing soot around the above-described rod bundle; a step of sintering the rod bundle around which the soot is deposited to obtain an optical fiber preform; and a step of drawing the optical fiber preform.

In the method of manufacturing an optical fiber according to one or more embodiments, in a case where the rod bundle is sintered or the optical fiber preform is drawn, the core rod is deformed to escape toward the spaces. Therefore, the optical fiber including an elliptical core can be easily manufactured.

According to one or more embodiments of the present invention, a rod bundle and a method of manufacturing an optical fiber can be manufactured, in which an optical fiber including an elliptical core can be manufactured with high quality stability and high efficiency and at low costs.

### BRIEF DESCRIPTION OF THE DRAWINGS

FIG. 1 is a transverse plane of an optical fiber manufactured using a method of manufacturing an optical fiber according to one or more embodiments.

FIG. 2A is a transverse plane of a rod bundle according to one or more embodiments.

FIG. 2B is a transverse plane of the rod bundle according to one or more embodiments, in a state where soot is deposited on an outer circumference of the rod bundle.

FIGS. 3A to 3E are diagrams showing steps of manufacturing the optical fiber according to one or more embodiments.

FIG. 4 is a transverse plane of an optical fiber according to one or more embodiments.

FIG. 5A is a transverse plane of a rod bundle according to one or more embodiments.

FIG. 5B is a transverse plane of the rod bundle according to one or more embodiments, in a state where soot is deposited on an outer circumference of the rod bundle.

### DETAILED DESCRIPTION

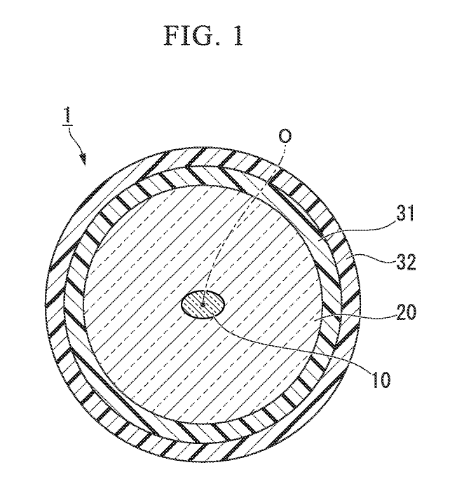

Hereinafter, a method of manufacturing an optical fiber and a rod bundle according to one or more embodiments will be described with reference to FIGS. 1 to 3E.

First, a configuration of an optical fiber which can be manufactured using the method of manufacturing of one or more embodiments will be described.

As shown in FIG. 1, an optical fiber 1 manufactured using the manufacturing method according to the one or more embodiments includes: a core 10; a clad 20 that surrounds the core 10; a primary layer 31 that covers the clad 20; and a secondary layer 32 that covers the primary layer 31. The core 10 is formed in an elliptical shape in a transverse plane of the optical fiber 1.

In one or more embodiments described herein, a longitudinal direction of the optical fiber 1 will be referred to as “longitudinal direction”. In addition, in a transverse plane perpendicular to the longitudinal direction, a direction perpendicular to a central axis line O of the optical fiber 1 will be referred to as “radial direction”, and a direction that rotates around the central axis line O will be referred to as “circumferential direction”.

In the description of a configuration of a rod bundle 1R described below, the longitudinal direction of the rod bundle 1R will be simply referred to as “longitudinal direction”. In addition, in a transverse plane perpendicular to the longitudinal direction, a direction perpendicular to a central axis line O of the rod bundle 1R will be referred to as “radial direction”, and a direction that rotates around the central axis line O will be referred to as “circumferential direction”.

Next, the manufacturing method according to one or more embodiments for manufacturing the optical fiber 1 having the above-described configuration will be specifically described.

### (Bundling Step)

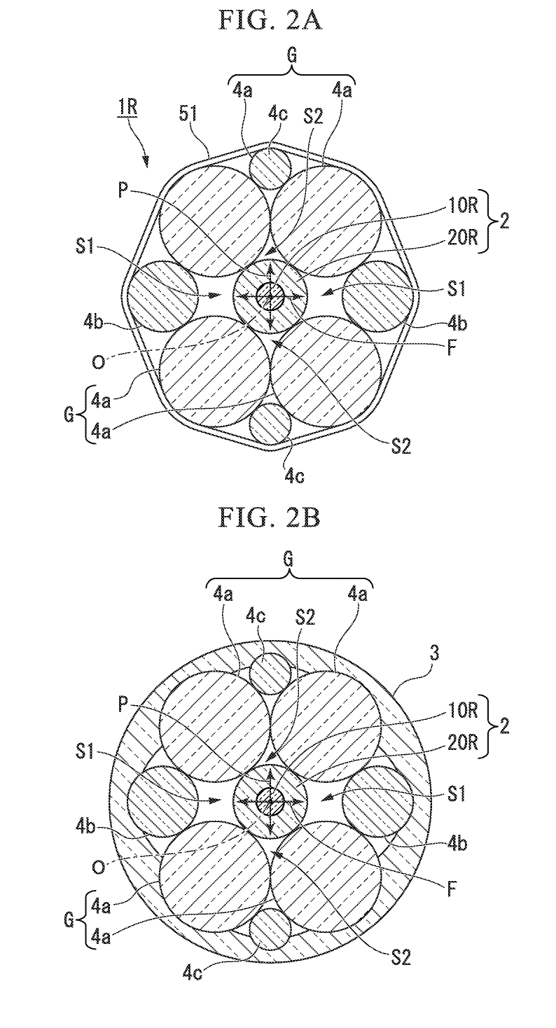

First, a core-clad rod 2, first filling rods 4a, second filling rods 4b, and third filling rods 4c shown in FIG. 2A are prepared.

The core-clad rod 2 includes: a core rod 10R that forms the core 10 of the optical fiber 1; and a cladding layer 20R that covers the core rod 10R. The core rod 10R is formed in a circular shape in the transverse plane. The cladding layer 20R forms a part of the clad 20 of the optical fiber 1.

The first filling rods 4a, the second filling rods 4b, and the third filling rods 4c form a part of the clad 20 of the optical fiber 1. The second filling rods 4b have substantially the same diameter as the core-clad rod 2. The first filling rods 4a have a larger diameter than the second filling rods 4b and the core-clad rod 2. The third filling rods 4c have a smaller diameter than the first filling rods 4a, the second filling rods 4b, and the core-clad rod 2.

In one or more embodiments, the rods 2 and 4a to 4c are disposed as shown in FIG. 2A and are bundled into the rod bundle 1R using a bundling band 51. Specifically, the rod bundle 1R includes: the core-clad rod 2 that is disposed at the center of the rod bundle 1R; four first filling rods 4a, two second filling rods 4b, and two third filling rods 4c that are disposed on the radially outside of the core-clad rod 2.

The four first filling rods 4a are disposed around the core-clad rod 2 so as to be in contact with or close to the core-clad rod 2 from the radially outside. In the circumferential direction, one of the first filling rods 4a is in contact with or close to one of adjacent two first filling rods 4a and apart from the other of the adjacent two first filling rods 4a.

The four first filling rods 4a compose two groups G of the first filling rods 4a. Two first filling rods 4a included in the group G are in contact with or close to each other in the circumferential direction. A pair of first space 51 described below is formed between the two groups G.

In FIG. 2A, all the four first filling rods 4a are in contact with the core-clad rod 2. However, the four first filling rods 4a are not necessarily in contact with the core-clad rod 2 as long as they are disposed so as to be sufficiently close to the core-clad rod 2. Likewise, the first filling rods 4a included in the group G are not necessarily in contact with each other as long as they are sufficiently close to each other.

The two second filling rods 4b are disposed opposite to each other with respect to the core-clad rod 2 in the radial direction. Hereinafter, in a transverse plane of the rod bundle 1R, a direction in which the two second filling rods 4b are opposite to each other will be referred to as “opposite direction F”. In addition, in a transverse plane of the rod bundle 1R, a direction perpendicular to the opposite direction F will be referred to as “perpendicular direction P”.

Each of the second filling rods 4b is disposed at a distance from the core-clad rod 2 in the opposite direction F. That is, each of the second filling rods 4b is disposed to be distant from the core-clad rod 2. In the circumferential direction, each of the second filling rods 4b is disposed between the two groups G of the first filling rods 4a. Each of the second filling rods 4b is disposed to be in contact with or close to the first filling rods 4a in the circumferential direction.

In FIG. 2A, the second filling rods 4b and the first filling rod 4a are in contact with each other. However, the second filling rods 4b and the first filling rod 4a are not necessarily in contact with each other as long as they are disposed sufficiently close to each other.

With the above-described configuration of one or more embodiments, in a transverse plane of the rod bundle 1R, a pair of first spaces S1 between which the core-clad rod 2 is interposed in the opposite direction F are formed. The pair of first spaces Si are formed on both sides of the core-clad rod 2 in the opposite direction F. A pair of second spaces S2 between which the core-clad rod 2 is interposed in the perpendicular direction P are formed. The pair of second spaces S2 are formed on both sides of the core- clad rod 2 in the perpendicular direction P. The pair of first spaces Si are positioned on both sides of the core-clad rod 2 in the opposite direction F and are adjacent to the core-clad rod 2. The pair of second spaces S2 are positioned on both sides of the core-clad rod 2 in the perpendicular direction P and are adjacent to the core-clad rod 2.

Each of the first spaces Si is formed by respective outer circumferential surfaces of the core-clad rod 2, a pair of first filling rods 4a disposed at a distance from each other in the circumferential direction, and the second filling rod 4b.

Each of the second spaces S2 is formed by respective outer circumferential surface of the core-clad rod 2 and a pair of first filling rods 4a included in the group G.

In the transverse plane of the rod bundle 1R, the area of each of the first spaces Si is larger than the area of each of the second spaces S2.

Each of the two third filling rods 4c is disposed to be in contact with or close to, in the circumferential direction, a pair of first filling rods 4a included in the group G. The two third filling rods 4c are disposed on both sides of the core-clad rod 2 in the perpendicular direction P.

The center of the third filling rod 4c is positioned radially outside of the center of the first filling rod 4a.

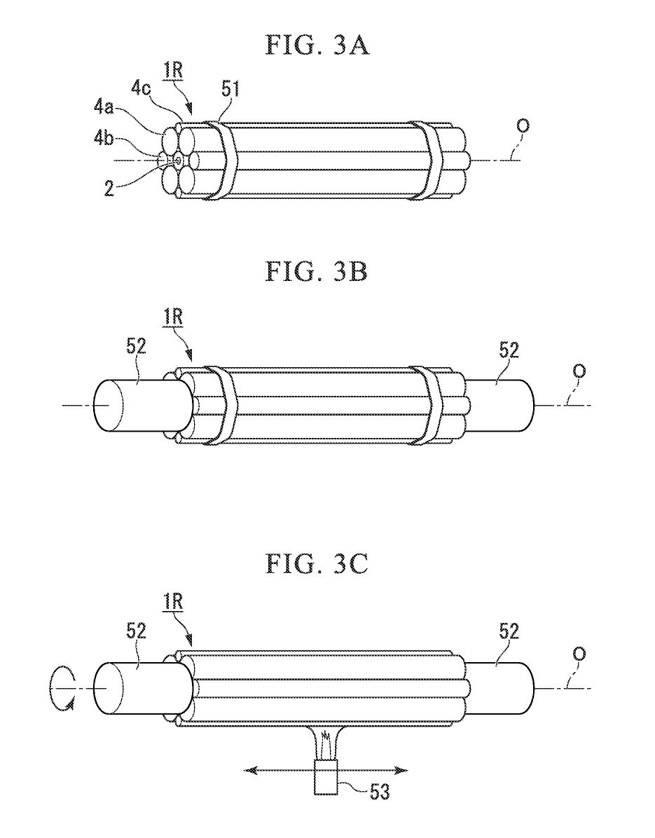

As shown in FIG. 3A, the bundling band 51 integrally bundles the rods 2 and 4a to 4c disposed as described above. The bundling band 51 may be formed of a resin or a metal. From the viewpoint of preventing the outer circumferential surfaces of the rods 2 and 4a to 4 c from being damaged, the bundling band 51 is formed of a resin. From the viewpoint of heat resistance, the bundling band 51 is formed of a metal.

This way, the rod bundle 1R according to one or more embodiments is obtained.

### (Welding Step)

In a welding step, as shown in FIG. 3B, dummy rods 52 for rotating the rod bundle 1R are fixed to both end portions of the rod bundle 1R in the longitudinal direction. From the viewpoint of preventing impurities from being attached to the rod bundle 1R or the like, the dummy rods 52 are fixed to the rod bundle 1R by welding.

### (Outside Vapor Deposition Step)

In an outside vapor deposition step, soot 3 is deposited around the rod bundle 1R using an outside vapor deposition method (OVD). The soot 3 forms a part of the clad 20 of the optical fiber 1.

In a case where the OVD method is used, vaporized SiCl₄ is introduced into flame of an oxyhydrogen burner 53, and the flame is applied to an outer circumference of the rod bundle 1R. At this time, while rotating the rod bundle 1R around the central axis line O by fixing the dummy rods 52 to a lathe or the like, the oxyhydrogen burner 53 is caused to reciprocate in a longitudinal direction (refer to FIG. 3C). At this time, as shown in FIG. 2B, the soot 3 is deposited around the rod bundle 1R.

### (Sintering Step)

In a sintering step, the rod bundle 1R around which the soot 3 is deposited is sintered in a furnace. As a result, the core-clad rod 2, the filling rods 4a to 4c, and the soot 3 are sintered together, and the soot 3 becomes a transparent glass body. Through the sintering step, an optical fiber preform 1P shown in FIG. 3D is obtained.

### (Drawing Step)

Next, as shown in FIG. 3E, a first end portion of the optical fiber preform 1P is tapered, and a second end portion thereof is attached to a silica tube 54. Through the silica tube 54, an internal space of the optical fiber preform 1P is depressurized using a vacuum pump or the like, and the optical fiber preform 1P is melted by heating. In this state, the optical fiber preform 1P is drawn. As a result, thin glass fiber (uncoated optical fiber) can be drawn. The drawn uncoated optical fiber is cooled in the air during the drawing step, is covered with the primary layer 31 and the secondary layer 32, and is wound around a bobbin or the like. This way, the optical fiber 1 is obtained.

Both the primary layer 31 and the secondary layer 32 are not necessarily formed. Any one of the primary layer 31 and the secondary layer 32 may be formed. In addition, in a step other than the drawing step, the primary layer 31 and the secondary layer 32 may be formed.

According to the rod bundle 1R, in a transverse plane of the rod bundle, a pair of first spaces 51 and a pair of second spaces S2 are formed. The core-clad rod 2 is interposed between the pair of first spaces 51 in the opposite direction F. The core-clad rod 2 is interposed between the pair of second spaces S2 in the perpendicular direction P perpendicular to the opposite direction F. Further, in the transverse plane, the area of each of the first spaces 51 is larger than the area of each of the second spaces S2. Therefore, during the sintering step or the drawing step, in the core rod 10R, a compressive force applied in the perpendicular direction P is higher than that applied in the opposite direction F. Due to a difference in compressive force, the core rod 10R is deformed to escape toward the first spaces S 1. Accordingly, the optical fiber 1 having the elliptical core 10 which has a major axis extending in the opposite direction F and a minor axis extending in the perpendicular direction P can be easily manufactured.

In addition, each of the first spaces Si is formed by respective outer circumferential surfaces of the core-clad rod 2, two first filling rods 4a, and the second filling rod 4b. The rod bundle 1R includes four first filling rods 4a, the first filling rods 4a have a larger diameter than the core-clad rod 2, and the second filling rods 4b have a smaller diameter than the first filling rods 4a. With the above-described configuration, the shape of the rod bundle 1R in the transverse plane is substantially circular as a whole. Therefore, in a case where the optical fiber preform 1P is prepared using the rod bundle 1R, the optical fiber preform 1P can be easily manufactured in a substantially cylindrical shape. Further, the first space Si is formed by the outer circumferential surfaces of the four rods. Therefore, in the transverse plane, the area of the first space Si is stabilized, and the core 10 can be formed in a desired elliptical shape.

In addition, the rod bundle 1R includes two third filling rods 4c having a smaller diameter than the first filling rods 4a and the second filling rod 4b, and each of the third filling rods 4c is in contact with two first filling rods 4a from the radially outside. With the above-described configuration, the shape of the rod bundle 1R in the transverse plane can be made to be more similar to a circular shape.

Next, additional embodiments will be described, and a basic configuration thereof is the same as the embodiments described above. Therefore, the same components are represented by the same reference numerals, and only different points will be described. In one or more embodiments, a configuration of a rod bundle and a shape of an optical fiber manufactured using the rod bundle in the transverse plane are different from those of the embodiments described above

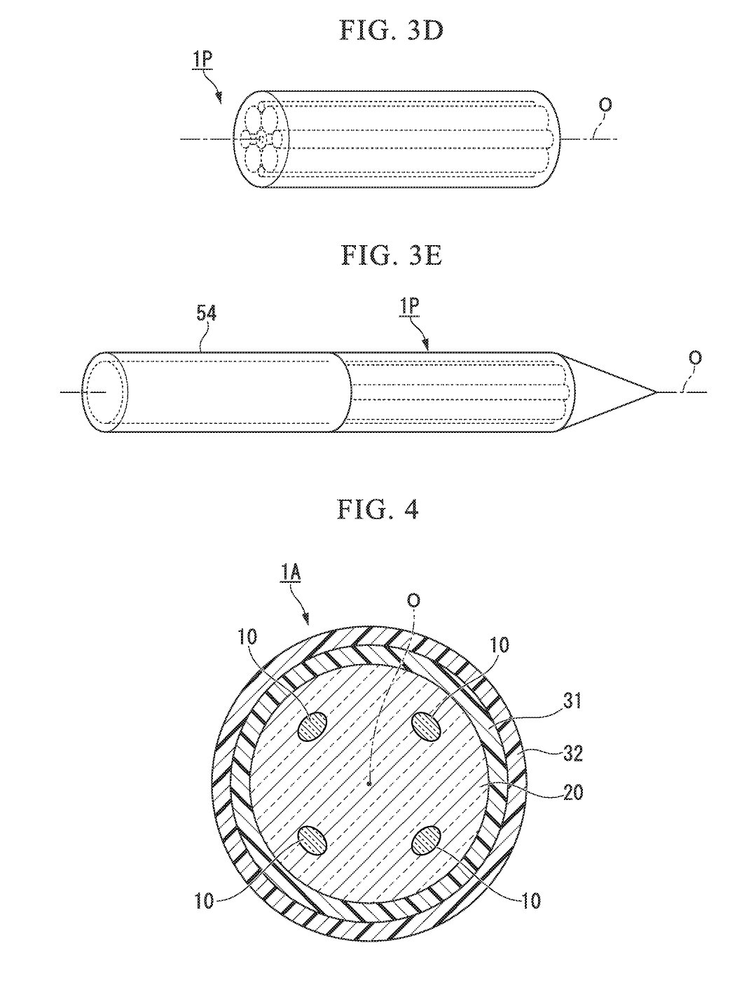

As shown in FIG. 4, an optical fiber 1A manufactured using the manufacturing method according to one or more embodiments includes four cores 10. The cores 10 are disposed at a regular distance from each other in the circumferential direction. In a transverse plane, each of the cores 10 is formed in an elliptical shape which has major axis extending in the circumferential direction and minor axis extending in the radial direction.

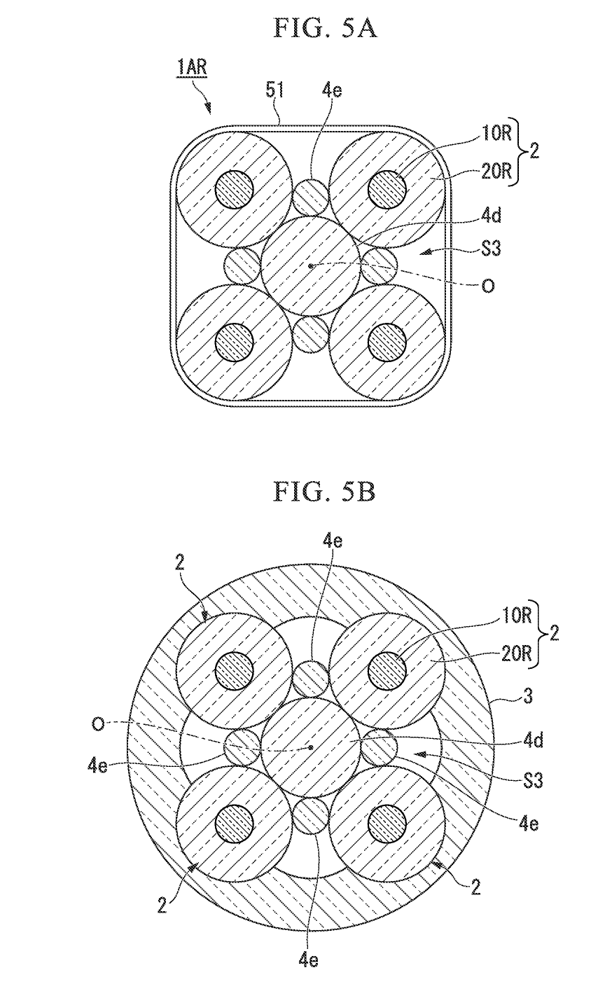

As shown in FIG. 5A, a rod bundle 1AR according one or more embodiments includes four core-clad rods 2, one fourth filling rod 4d, and four fifth filling rods 4e. The fourth filling rod 4d is disposed at the center of the rod bundle 1AR. The core-clad rods 2 are disposed around the fourth filling rod 4d to be in contact with the fourth filling rod 4d from the radially outside. The core-clad rods 2 are disposed at a distance from each other in the circumferential direction. Therefore, third spaces S3 are formed in the circumferential direction between core-clad rods 2 adjacent to each other in the circumferential direction.

Fifth filling rods 4e are disposed between pairs of core-clad rods 2 adjacent to each other in the circumferential direction. The fifth filling rods 4e have a smaller diameter than the core-clad rods 2 and the fourth filling rod 4d. The fourth filling rod 4d has a smaller diameter than the core-clad rods 2.

In the rod bundle 1AR according one or more embodiments, the third spaces S3 have openings to the radially outside. Therefore, in the outside vapor deposition step, the thickness of the soot 3 is adjusted such that the third spaces S3 are not filled with the soot 3. For example, as shown in FIG. 5B, the thickness of the soot 3 may be adjusted so as to be less than a value obtained by subtracting the outer diameter of the fifth filling rod 4e from the outer diameter of the core-clad rod 2.

The thickness of the soot 3 can be adjusted, for example, by changing the number of times in which the oxyhydrogen burner 53 reciprocates in the outside vapor deposition step.

As described above, in the rod bundle 1AR according to one or more embodiments, the third spaces S3 are formed between core-clad rods 2 adjacent to each other in the circumferential direction. In addition, each of the core-clad rod 2 is in contact with the fourth filling rod 4d from the radially outside. According to one or more embodiments, during the sintering step or the drawing step, the core rods 10R receive a compressive force from the fourth filling rod 4d and are deformed to escape toward the third spaces S3 in the circumferential direction. Accordingly, in the transverse plane, the optical fiber 1 including a plurality of cores 10 those have major axes extending in the circumferential direction and minor axes extending in the radial direction can be easily formed.

In addition, due to the fifth filling rods 4e disposed between the core-clad rods 2 adjacent to each other in the circumferential direction, the area of the third spaces S3 in the transverse plane can be stabilized. As a result, the cores 10 of the optical fiber 1 can be easily formed in a desired elliptical shape.

The technical scope of the present invention is not limited to the above-described embodiments, and various modifications can be made within a range not departing from the scope of the present invention.

For example, in one or more embodiments, the diameter of the third filling rods 4c may be equal to or larger than that of the second filling rods 4b. Alternatively, the rod bundle 1R may not include the third filling rods 4c.

In addition, in FIG. 2A, two of the first filling rods 4a are disposed on one side of the core-clad rod 2 in the perpendicular direction P, and the other two of the first filling rods 4a are disposed on the other side of the core-clad rod 2 in the perpendicular direction P. However, another configuration may be adopted. For example, in a case where three or more first filling rods 4a having a smaller diameter than that shown in the drawing are that are disposed in the circumferential direction is set as one filling rod row, a pair of filling rod rows may be disposed opposite to each other with respect to the core-clad rod 2 in the perpendicular direction P.

In addition, the rod bundle 1AR shown in FIG. 5A includes four core-clad rods 2. However, the rod bundle 1AR may include two, three, or five or more core-clad rods 2. In this case, the number of fifth filling rods 4e included in the rod bundle AR may be the same as the number of core-clad rods 2.

In addition, the diameters, dispositions, numbers, and the like of the core-clad rods 2 and the filling rods 4a to 4e in the rod bundle 1R or 1AR may be modified, and other filling rods may be appropriately disposed in addition to the filling rods 4a to 4e.

In addition, in FIGS. 2A and 5A, adjacent rods included in the rod bundle 1R or 1AR are disposed to be in contact with each other, but some of adjacent rods may be close to each other instead of being in contact with each other. In a case where adjacent rods included in the rod bundle 1R or 1AR are close to each other, spaces between the rods close to each other may be filled during the sintering step or the drawing step. Therefore, this configuration is substantially the same as the configuration where the adjacent rods in the rod bundle 1R or 1AR are in contact with each other.

In addition, within a range not departing from the scope of the present invention, the components according one or more embodiments may be appropriately replaced with well-known components, and the embodiments and modification examples may be appropriately combined.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A rod bundle comprising:
a core-clad rod that includes a core rod and a cladding layer that covers the core rod;
a plurality of first filling rods disposed around the core-clad rod to be in contact with the core-clad rod; and
two second filling rods that are disposed opposite to each other and interposing the core-clad rod therebetween to be distant from the core-clad rod and form first spaces with the core-clad rod,
wherein a pair of second spaces that are adjacent to the core-clad rod are formed to interpose the core-clad rod therebetween in a direction perpendicular to a direction in which the two second filling rods are opposite to each other, and
wherein, in a transverse plane, an area of each of the first spaces is more than an area of each of second spaces.

2. The rod bundle according to claim 1,
wherein the number of the first filling rods is four,
the first filling rods have a larger diameter than the core-clad rod,
the second filling rods have a smaller diameter than the first filling rods, and
each of the first spaces is formed by outer circumferential surfaces of the core-clad rod, two of the first filling rods, and each of the second filling rods.

3. The rod bundle according to claim 2, further comprising:
two third filling rods having a smaller diameter than the first filling rods and the second filling rods,
wherein each of the third filling rods is in contact with two of the first filling rods from a radially outside.

4. A rod bundle comprising:
a fourth filling rod; and
a plurality of core-clad rods that are disposed around and in contact with the fourth filling rod, each of the core-clad rods including a core rod, and a cladding layer covering the core rod,
wherein third spaces are formed between the core-clad rods in a circumferential direction.

5. The rod bundle according to claim 4, further comprising:
a fifth filling rod having a smaller diameter than the core-clad rods and the fourth filling rod,
wherein the fifth filling rod is disposed between a pair of the core-clad rods adjacent to each other in the circumferential direction.

6. A method of manufacturing an optical fiber comprising:
depositing soot around the rod bundle according to claim 1;
sintering the rod bundle around where the soot is deposited to obtain an optical fiber preform; and
drawing the optical fiber preform.
